(19) United States
(12) Patent Application Publication
(10) Pub. No.: US 2025/0238457 A1
(43) Pub. Date: Jul. 24, 2025

(54) TECHNIQUES FOR DETECTING HALLUCINATION IN MACHINE-GENERATED RESPONSES

(71) Applicant: LIVEPERSON, INC., New York, NY (US)

(72) Inventors: Ilana Zimmerman, New York, NY (US); Jadin Tredup, New York, NY (US); Joseph Bradley, New York, NY (US)

(73) Assignee: LIVEPERSON, INC., New York, NY (US)

(21) Appl. No.: 19/034,900

(22) Filed: Jan. 23, 2025

Related U.S. Application Data
(60) Provisional application No. 63/624,416, filed on Jan. 24, 2024.

(51) Int. Cl. G06F 16/355; G06N 5/02

(52) U.S. Cl. CPC G06F 16/355; G06N 5/02

(57) ABSTRACT

Systems and methods may provide techniques for detecting hallucination in machine-generated responses. A computer-implemented method can include accessing text data. The text data can include one or more machine-generated responses that are supplemented by outputs generated by a retrieval-augmentation generation (RAG) system. In some instances, the outputs are associated with the prompt associated with a user. The computer-implemented method can also include applying one or more hallucination-detection models to the text data to generate a set of classification labels. A classification label can indicate whether a corresponding machine-generated response of the one or more machine-generated responses contradicts at least part of the knowledge base accessed by the RAG system. The computer-implemented method can also include generating annotated text data that includes the one or more machine-generated responses annotated with corresponding classification labels of the set of classification labels. The computer-implemented method can also include outputting the annotated text data.

### CROSS-REFERENCES TO RELATED APPLICATIONS

The present application claims priority from and is a non-provisional of U.S. Provisional Application No. 63/624,416, entitled “TECHNIQUES FOR DETECTING HALLUCINATION IN MACHINE-GENERATED RESPONSES” filed Jan. 24, 2024, the contents of which are herein incorporated by reference in its entirety for all purposes.

### FIELD

The present disclosure relates generally to detecting hallucination in machine-generated responses. In one example, the systems and methods described herein may be used to detect hallucination in machine-generated responses using multilabel or two-tiered hallucination-detection models.

### SUMMARY

Disclosed embodiments may provide techniques for detecting hallucination in machine-generated responses. A computer-implemented method can include accessing text data. The text data can include one or more machine-generated responses initially generated by a generative machine-learning model (e.g., an LLM) in response to a prompt submitted by a user. In some instances, the one or more machine-generated responses that are supplemented by outputs generated by a retrieval-augmentation generation (RAG) system. In some instances, the outputs are associated with the prompt associated with a user.

To generate the abovementioned outputs, the RAG system can access a knowledge base stored in database server. In some instances, the knowledge base includes domain-specific information, which can be associated with a particular domain. Examples of domains can include real property, cybersecurity, fintech, telecom, healthcare, finance, energy, media and entertainment, pharmaceuticals, consumer goods (e.g., sporting goods), and environment.

In some instances, the outputs are generated by encoding the prompt into one or more embeddings. When the one or more embeddings are entered in the database, the RAG system can use prompt results outputted from the database server to supplement the one or more machine-generated responses.

The computer-implemented method can also include applying one or more hallucination-detection models to the text data to generate a set of classification labels. A classification label can indicate whether a corresponding machine-generated response of the one or more machine-generated responses contradicts at least part of the knowledge base accessed by the RAG system. In some instances, the one or more hallucination-detection models were trained using a training dataset that includes previous machine-generated responses annotated with the set of classification labels. The one or more hallucination-detection models can include a pretrained Decoding-enhanced Bidirectional Encoder Representations from Transformers with Disentangled attention (DeBERTa) model and/or a pretrained LLM.

In some instances, a single hallucination-detection model is applied to classify the machine-generated responses. For example, the single hallucination-detection model can generate the set of classification labels that include: (i) a no-info classification label indicating that the corresponding machine-generated response includes non-verifiable information; (ii) a supported classification label indicating that the corresponding machine-generated response is supported by the knowledge base; and (iii) an unsupported classification label indicating that the corresponding machine-generated response contradicts the at least part of the knowledge base.

Additionally or alternatively, two or more hallucination-detection models can be applied to classify the machine-generated responses. For example, a first hallucination-detection model generates a classification label indicating whether the corresponding machine-generated response includes information verifiable from the knowledge base. If the classification label indicates verifiable information (e.g., a “verifiable” classification label), a second hallucination-detection model can be applied to the corresponding machine-generated response to generate the classification label indicating whether the corresponding machine-generated response contradicts at least part of the knowledge base (e.g., a “supported” classification label, an “unsupported” classification label). Conversely, if the machine-generated response does not include verifiable information, the hallucination-detection system can generate a “no-info” classification label indicating that the corresponding machine-generated response includes non-verifiable information.

The computer-implemented method can also include generating annotated text data that includes the one or more machine-generated responses annotated with corresponding classification labels of the set of classification labels. The computer-implemented method can also include outputting the annotated text data. In some instances, outputting the annotated text data includes displaying in real-time the annotated text data on a graphical user interface, as messages are exchanged between the user and an agent during an instant-chat session.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 illustrates an example schematic diagram for detecting hallucination in machine-generated responses, according to some embodiments.

FIG. 2 shows an illustrative example of a process for detecting hallucination in machine-generated responses, in accordance with some embodiments.

FIG. 3 illustrates an example schematic diagram for training and deploying a multilabel hallucination-detection model for detecting hallucination in machine-generated responses, according to some embodiments.

FIG. 4 illustrates an example schematic diagram for training and deploying a two-tiered binary hallucination-detection models for detecting hallucination in machine-generated responses, according to some embodiments.

FIG. 5 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

In recent years, generative Large Language Models (LLMs) have been adopted industry wide for use as artificial intelligence (AI) assistants in various domains. LLMs have an impressive ability to convincingly answer questions ranging in subjects from pop-culture to law. These LLMs can even cite sources, but it often becomes questionable as to whether such information is accurate and/or verifiable. In some situations, the LLMs generate “hallucinations”, which can be described as machine-generated responses that are incorrect or misleading. These errors can be caused by a variety of factors, including insufficient training data, incorrect assumptions made by the model, or biases in the data used to train the model.

The abilities of LLMs can be assessed across various evaluation metrics such as common-sense reasoning (HellaSwag, Winogrande), mathematics (GSM8k), and factualness (TruthfulQA). In addition to the above evaluation metrics, there is a need to develop an additional evaluation metric that identifies model hallucinations with respect to a ground source of truth. The risks associated with LLM hallucinations can vary by domain, and there is a need to identify an effective method to identify them.

Moreover, evaluating generative LLMs for factual consistency with respect to a knowledge base has become increasingly challenging, especially for retrieval augmented generation (RAG) systems in industry. Today, there are existing solutions for solving such problem, including prompting ChatGPT to judge factual consistency or fine-tuning NLI models on predominantly human-written QA and summary data sets using public data sources. However, the existing techniques fail to evaluate on industry production grade RAG systems, and few handle non-verifiable statements such as small-talk or questions. Implementing such existing techniques to detect hallucination in machine-generated responses can thus be inefficient and inaccurate.

To address the abovementioned challenges, disclosed embodiments of the present disclosure may provide techniques for detecting hallucination in machine-generated responses. In particular, the present techniques can include end-to-end hallucination-detection system that address hallucination detection in enterprise. The present techniques are specifically developed to identify hallucinations stemming from a retrieval-automation generation system (RAG) based customer service virtual assistant, but can be shown to generalize across various domains. In some implementations, the hallucination-detection system can expedite the time agents spend responding to users in a customer service setting, while ensuring any potential misinformation generated by the LLM is flagged for additional review.

The present techniques can implement two different modeling approaches for hallucination detection, each following a three-label taxonomy (SUPPORTED, UNSUPPORTED, NO-INFO). A first approach is to use a single multilabel hallucination-detection model. A second approach is a two-tiered solution in which there are two binary hallucination-detection models that: (1) identify factually verifiable statements (e.g., NO-INFO vs VERIFIABLE classification labels); and (2) for VERIFIABLE statements, classify statements as SUPPORTED or UNSUPPORTED. In production, all UNSUPPORTED statements can be flagged for additional review.

Various implementations of the hallucination-detection models can be optimized for performance on production RAG data that outperforms existing techniques and generalizes across various domains. The hallucination-detection models can also be configured to provide a new end-to-end solution that distinguishes between verifiable claims and non-verifiable machine-generated responses. In addition, the hallucination-detection models can be trained on various training datasets, including open-source data and production RAG data. Accordingly, the present techniques demonstrate a significant improvement over existing techniques that fail to evaluate performance of detecting model hallucination.

### I. Overview of Detecting Hallucination in Machine-Generated Responses

### A. Example Implementation

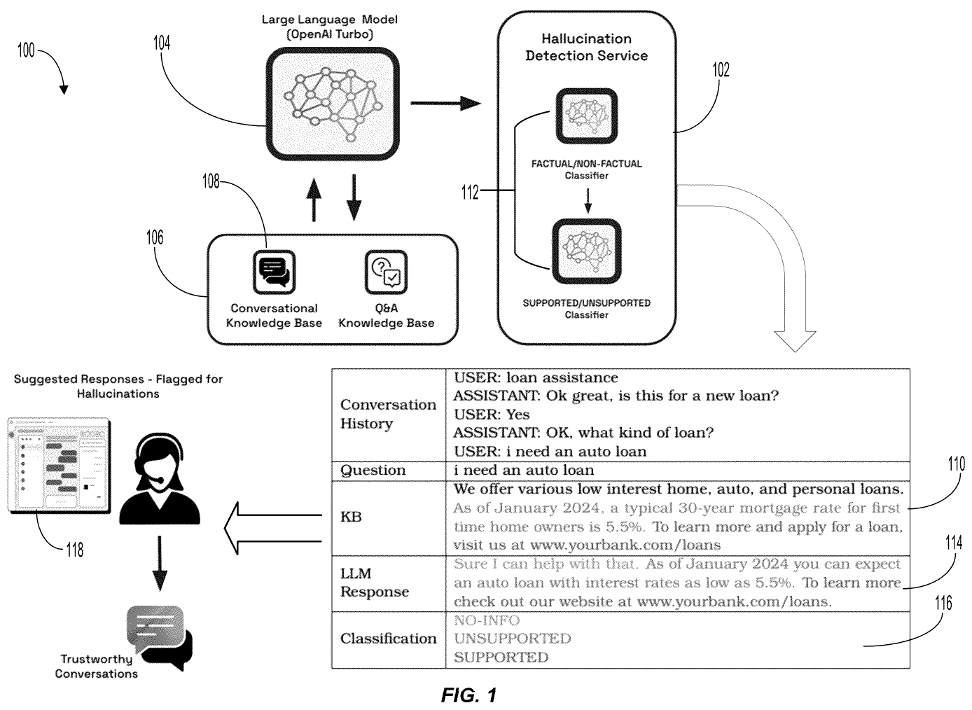

FIG. 1 illustrates an example schematic diagram for detecting hallucination in machine-generated responses, according to some embodiments. As shown in FIG. 1, a hallucination-detection system 102 can access text data. The text data can include one or more machine-generated responses initially generated by a generative machine-learning model 104 (e.g., an LLM) in response to a prompt submitted by a user. Prompts can be used as a means for generating machine-generated responses, which can be used to accomplish different tasks. Example prompts can include instructions, questions, or any other types of text input submitted a user or generated by another system.

In an illustrative example shown in FIG. 1, the text data can include a machine-generated response “Sure I can help with that. As of January 2024 you can expect an auto loan with interest rates as low as 5.5%. To learn more check out our website at www.yourbank.com/loans”, which was generated in response a prompt “I need an auto loan.” In some embodiments, the text data can include 1, 2, 3, 4, 5, 10, 15, 20, 25, 50, or more than 50 machine-generated responses.

In some instances, the one or more machine-generated responses that are supplemented by outputs generated by a retrieval-augmentation generation (RAG) system 106. The RAG system 106 can be configured to optimize the outputs (e.g., the machine-generated responses) of an LLM by referencing an external knowledge base that is outside of the training data used for training the LLM. In some instances, the outputs are associated with the prompt associated with a user. For example, the outputs that supplement the machine-generated response can correspond to “As of January 2024 you can expect an auto loan with interest rates as low as 5.5%. To learn more check out our website at www.yourbank.com/loans”.

To generate the abovementioned outputs, the RAG system 106 can access a knowledge base 108 stored in database server. The knowledge base 108 can include a repository that stores information associated with a product, service, domain, or a topic, which can be used to supplement responses generated by LLM. In some instances, the knowledge base includes domain-specific information, which can be associated with a particular domain. Examples of domains can include real property, cybersecurity, fintech, telecom, healthcare, finance, energy, media and entertainment, pharmaceuticals, consumer goods (e.g., sporting goods), and environment.

Continuing with the example in FIG. 1, the knowledge base 108 can include domain-specific information 110 that includes “We offer various low interest home, auto, and personal loans. As of January 2024, a typical 30-year mortgage rate for first time homeowners is 5.5%. To learn more and apply for a loan, visit us at www.yourbank.com/loans.” Since the domain-specific information 110 describes information regarding mortgage loans, the machine-generated response “As of January 2024 you can expect an auto loan with interest rates as low as 5.5%” contradicts the knowledge base 108 because it relates to an auto loan that is not represented by the knowledge base 108.

In some instances, the outputs are generated by encoding the prompt into one or more embeddings. Example techniques for encoding the prompt can include term frequency-inverse document frequency (TF-IDF) techniques, word-embedding techniques, and tokenization techniques. When the one or more embeddings are entered in the database, the RAG system 106 can use prompt results outputted from the database server to supplement the one or more machine-generated responses.

The hallucination-detection system 102 can apply one or more hallucination-detection models 112 to the text data to generate a set of classification labels. A classification label can indicate whether a corresponding machine-generated response of the one or more machine-generated responses contradicts at least part of the knowledge base 108 accessed by the RAG system 106. For example, the classification labels can include classification labels 116 shown in FIG. 1. Table 1 provides example definitions that describe the scope of the set of classification labels.

TABLE 1

| Classification label | Definition |
|---|---|
| NO-INFO | Any statement not containing factually verifiable information. This |
| | includes small talk, and usually “I can't help you.” This also includes |
| | statements regarding escalating to a human, without specific contact |
| | information. For example, a no-info labeled statement can include |
| | “Please visit a bank branch for assistance.” |
| SUPPORTED | Any factual statement represented in the retrieved Knowledge Articles. |
| | In the event the LLM responds “I don't have the answer to your |
| | question” and the answer does not exist in the Knowledge Article, then |
| | the label is “SUPPORTED.” |
| UNSUPPORTED | Any factual statement not represented in (or contradicted by) the |
| | Knowledge Article. |
| VERIFIABLE | A factually verifiable statement. This includes both SUPPORTED and |
| | UNSUPPORTED claims. |

Continuing with the example in FIG. 1, the machine-generated response “As of January 2024 you can expect an auto loan with interest rates as low as 5.5%” can be associated with a generated classification label indicating that the machine-generated response contradicts the knowledge base 108, because the knowledge base 108 describes information regarding mortgages while the machine-generated response includes information regarding auto loans. In another example, the machine-generated response “To learn more check out our website at www.yourbank.com/loans” can be associated with a generated classification label indicating that the machine-generated response is supported by the knowledge base 108, because both the machine-generated response and the knowledge base 108 describe the same hyperlink “www.yourbank.com/loans” for the corresponding website.

In some instances, the one or more hallucination-detection models 112 were trained using a training dataset that includes previous machine-generated responses annotated with the set of classification labels. In some instances, the one or more hallucination-detection models 112 can include a pretrained Decoding-enhanced Bidirectional Encoder Representations from Transformers with Disentangled attention (DeBERTa) model and/or a pretrained LLM. Other examples of the hallucination-detection models 112 can include, but are not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like.

In some instances, a single hallucination-detection model is applied to classify the machine-generated responses. For example, the single hallucination-detection model can generate the set of classification labels that include: (i) a no-info classification label indicating that the corresponding machine-generated response includes non-verifiable information; (ii) a supported classification label indicating that the corresponding machine-generated response is supported by the knowledge base; and (iii) an unsupported classification label indicating that the corresponding machine-generated response contradicts the at least part of the knowledge base. Example implementations of training and deploying the single hallucination-detection model are described in Section II of the present disclosure.

Additionally or alternatively, two or more hallucination-detection models can be applied to classify the machine-generated responses. For example, a first hallucination-detection model generates a classification label indicating whether the corresponding machine-generated response includes information verifiable from the knowledge base. If the classification label indicates verifiable information (e.g., a “verifiable” classification label), a second hallucination-detection model can be applied to the corresponding machine-generated response to generate the classification label indicating whether the corresponding machine-generated response contradicts at least part of the knowledge base (e.g., a “supported” classification label, an “unsupported” classification label). Conversely, if the machine-generated response does not include verifiable information, the hallucination-detection system 102 can generate a “no-info” classification label indicating that the corresponding machine-generated response includes non-verifiable information. Example implementations of training and deploying the two or more hallucination-detection models are described in Section III of the present disclosure.

The hallucination-detection system 102 can generate annotated text data 114 that includes the one or more machine-generated responses annotated with corresponding classification labels of the set of classification labels. Continuing with the example in FIG. 1, the annotated text data 114 can include: (i) a first machine-generated response “Sure I can help with that.” annotated with a no-info classification label; and (ii) a second machine-generated response “As of January 2024 you can expect an auto loan with interest rates as low as 5.5%” annotated with an unsupported classification label; and (iii) a third machine-generated response “To learn more check out our website at www.yourbank.com/loans” annotated with a supported classification label. The annotated text data can allow the user to efficiently identify factually unverifiable information from the machine-generated responses.

The hallucination-detection system 102 can output the annotated text data 114. In some instances, outputting the annotated text data includes displaying in real-time the annotated text data on a graphical user interface, as messages are exchanged between the user and an agent during an instant-chat session 118.

### B. Methods

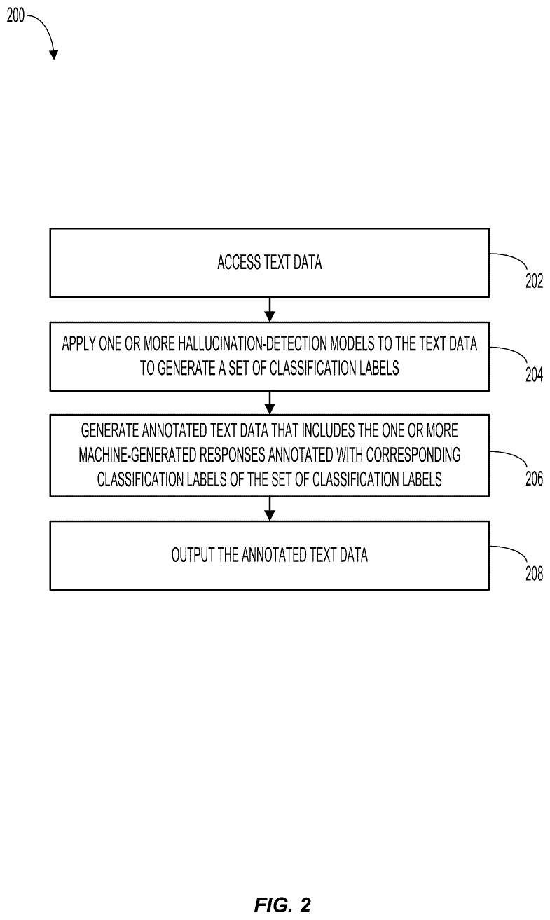

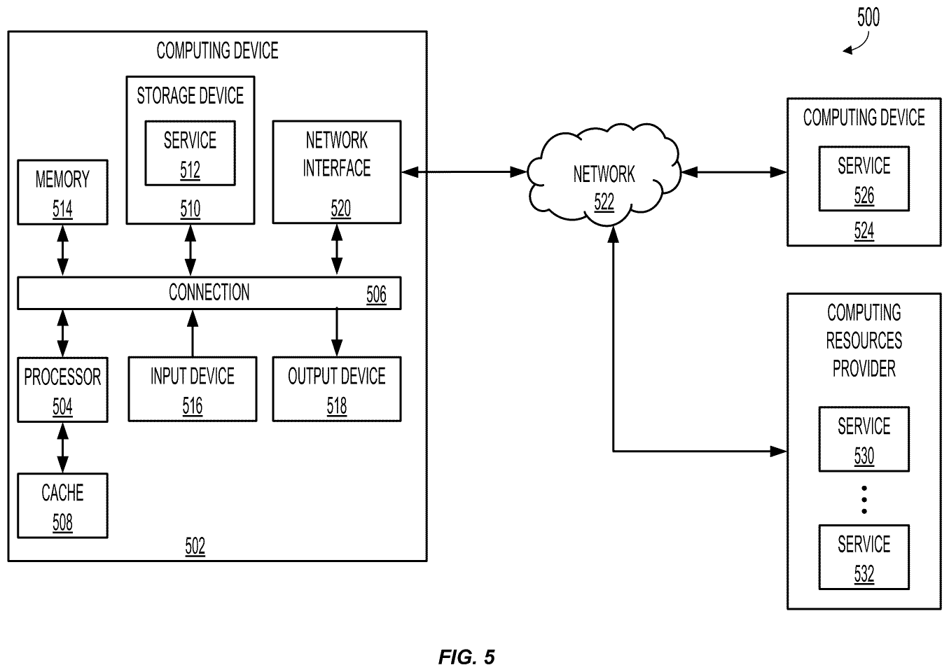

FIG. 2 shows an illustrative example of a process 200 for detecting hallucination in machine-generated responses, in accordance with some embodiments. For illustrative purposes, the process 200 is described with reference to the components illustrated in FIG. 1, though other implementations are possible. For example, the program code for the hallucination-detection system 102 of FIG. 1 is executed by one or more processing devices to cause a server system (e.g., the computing device 502 of FIG. 5) to perform one or more operations described herein.

At step 202, a hallucination-detection system can access text data. The text data can include one or more machine-generated responses initially generated by a generative machine-learning model (e.g., an LLM) in response to a prompt submitted by a user. Prompts can be used as a means for generating machine-generated responses, which can be used to accomplish different tasks. Example prompts can include instructions, questions, or any other types of text input submitted a user or generated by another system. In some embodiments, the text data can include 1, 2, 3, 4, 5, 10, 15, 20, 25, 50, or more than 50 machine-generated responses.

In some instances, the one or more machine-generated responses are supplemented by outputs generated by a retrieval-augmentation generation (RAG) system. The RAG system can be configured to optimize the outputs (e.g., the machine-generated responses) of an LLM by referencing an external knowledge base that is outside of the training data used for training the LLM. In some instances, the outputs are associated with the prompt associated with a user.

To generate the abovementioned outputs, the RAG system can access a knowledge base stored in database server. The knowledge base can include a repository that stores information associated with a product, service, domain, or a topic, which can be used to supplement responses generated by LLM. In some instances, the knowledge base includes domain-specific information, which can be associated with a particular domain. Examples of domains can include real property, cybersecurity, fintech, telecom, healthcare, finance, energy, media and entertainment, pharmaceuticals, consumer goods (e.g., sporting goods), and environment.

In some instances, the outputs are generated by encoding the prompt into one or more embeddings. Example techniques for encoding the prompt can include term frequency-inverse document frequency (TF-IDF) techniques, word-embedding techniques, and tokenization techniques. When the one or more embeddings are entered in the database, the RAG system can use prompt results outputted from the database server to supplement the one or more machine-generated responses.

At step 204, the hallucination-detection system can apply one or more hallucination-detection models to the text data to generate a set of classification labels. A classification label can indicate whether a corresponding machine-generated response of the one or more machine-generated responses contradicts at least part of the knowledge base accessed by the RAG system.

In some instances, the one or more hallucination-detection models were trained using a training dataset that includes previous machine-generated responses annotated with the set of classification labels. For example, each of the previous machine-generated responses can be associated with a corresponding classification label indicating whether the previous response contradicts the knowledge base.

In some instances, the one or more hallucination-detection models can include a pretrained Decoding-enhanced Bidirectional Encoder Representations from Transformers with Disentangled attention (DeBERTa) model and/or a pretrained LLM. Other examples of the hallucination-detection models can include, but are not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like.

In some instances, a single hallucination-detection model is applied to classify the machine-generated responses. For example, the single hallucination-detection model can generate the set of classification labels that include: (i) a no-info classification label indicating that the corresponding machine-generated response includes non-verifiable information; (ii) a supported classification label indicating that the corresponding machine-generated response is supported by the knowledge base; and (iii) an unsupported classification label indicating that the corresponding machine-generated response contradicts the at least part of the knowledge base. Example implementations of training and deploying the single hallucination-detection model are described in Section II of the present disclosure.

Additionally or alternatively, two or more hallucination-detection models can be applied to classify the machine-generated responses. For example, a first hallucination-detection model generates a classification label indicating whether the corresponding machine-generated response includes information verifiable from the knowledge base. If the classification label indicates verifiable information (e.g., a “verifiable” classification label), a second hallucination-detection model can be applied to the corresponding machine-generated response to generate the classification label indicating whether the corresponding machine-generated response contradicts at least part of the knowledge base (e.g., a “supported” classification label, an “unsupported” classification label). Conversely, if the machine-generated response does not include verifiable information, the hallucination-detection system can generate a “no-info” classification label indicating that the corresponding machine-generated response includes non-verifiable information. Example implementations of training and deploying the two or more hallucination-detection models are described in Section III of the present disclosure.

At step 206, the hallucination-detection system can generate annotated text data that includes the one or more machine-generated responses annotated with corresponding classification labels of the set of classification labels. At step 208, the hallucination-detection system can output the annotated text data. In some instances, outputting the annotated text data includes displaying in real-time the annotated text data on a graphical user interface, as messages are exchanged between the user and an agent during an instant-chat session. Process 200 terminates thereafter.

### II. Multilabel Hallucination-Detection Model for Detecting Hallucination in Machine-Generated Responses

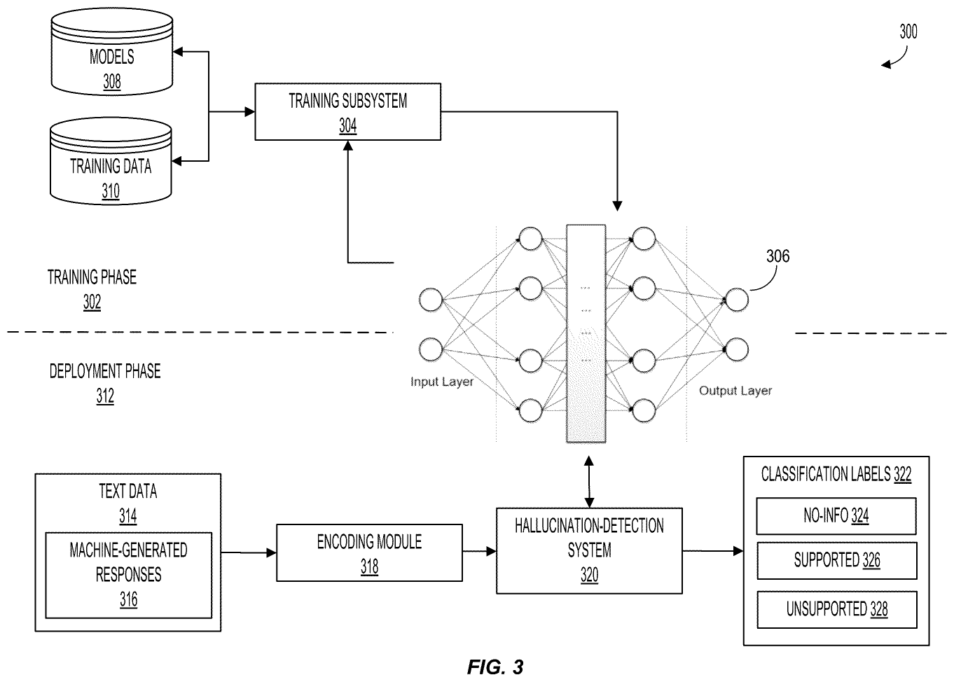

FIG. 3 illustrates an example schematic diagram 300 for training and deploying a multilabel hallucination-detection model for detecting hallucination in machine-generated responses, according to some embodiments.

### A. Model Selection

As shown in FIG. 3, the machine-learning techniques for detecting hallucination in machine-generated responses can include training a multilabel hallucination-detection model to generate classification labels that indicate whether a given machine-generated response contradicts an external knowledge base. A training phase 302 can be initiated by a training subsystem 304 accessing an initial multilabel hallucination-detection model 306 from a models database 308. In some instances, the initial multilabel hallucination-detection model 306 can include a pretrained Decoding-enhanced Bidirectional Encoder Representations from Transformers with Disentangled attention (DeBERTa) model and/or a pretrained LLM.

### 1. Pretrained Decoder LLM

LLMs have been recognized for their learned world knowledge and large token limits (CITE). Because grounding context for hallucination detection can widely vary in length, fine-tuned LLMs can be used as an encoder-based solution for detecting hallucinations in machine-generated responses. For example, Mistral-7b-Instruct trained to classify one sentence at a time was fine-tuned. In the context of RAG, the model was given the input prompt including the user's question, retrieved KBs, and a sentence from the LLM Response (the statement being classified for factual consistency). These information were used to train the model to produce one of the labels from the taxonomy described in Table 1.

The mistral model was fine-tuned using Deepspeed Zero Stage 1 optimization (Samyam Rajbhandari, 2020), batch size of 1, gradient accumulation steps of 4, floating point 16 precision, a learning rate of 5e-6, and 4 epochs. The maximum token limit for this model is 2048.

### 2. DeBERTa Model

The DeBERTa model is a type of machine-learning model that improves from previous BERT and RoBERTa models by implementing two distinguishing features: (i) a disentangled attention mechanism; and (ii) an enhanced masked decoder. The BERT model represents each word by a single vector, which can be computed by the sum of its word embedding and an absolute position embedding. In contrast, DeBERTa separates or disentangles these embeddings into two different vectors, thereby representing each word by two vectors. The attention weights can be computed using disentangled matrices on their word and relative position. The reason behind this approach is that the attention weight of a word pair not only depends on the content of the words but also on their relative position. For example, consider the words “deep” and “learning”. Their dependency is much stronger when their position to each other is smaller than when their position to each other is larger.

Enhanced mask decoder BERT uses masked language modelling (MLM). This is a fill-in-the-blank task, where the model learns to predict what word a token should mask, based on its context, i.e., the words surrounding the mask token. DeBERTa also uses MLM while pre-training. Their disentangled attention mechanism already considers the contents and relative positions of the context words but not their absolute positions. The absolute positions are in many cases crucial and can help the model learn syntactical nuances which would not be tangible if it only considered the relative position. Consider this example:
“a new store opened beside the new mall”
“a new <mask1> opened beside the new <mask2>”
   The masked tokens “store” and “mall” have a similar context, but store is the subject and mall is the object. These syntactical nuances can only be learned by considering the absolute position of the masked tokens. DeBERTa can incorporate these absolute word embeddings before the Softmax layer, right before the model decodes the masked words based on the contextual embedding (word contents and positions). Accordingly, the DeBERTa model can combine the relative and absolute position to exceed the results of previous models.

The DeBERTa encoder models can thus be selected for detecting hallucination for several reasons. First, from an industry practicality standpoint, the DeBERTa models are substantially smaller and faster than other machine-learning models. Further, encoders are known to be more powerful than decoder-only models because they encode relative context both in front of and behind each token. While the LLMs are often preferred for their high token limits, the relative position embeddings of the DeBERTa encoder model allows for a theoretical maximum token limit of 24,528 (Pengcheng He, 2021).

### 3. Artificial Neural Networks

For example, the multilabel hallucination-detection model 306 can be an artificial neural network selected from the models database 308. The neural network can be defined by an example neural network description for machine learning in a neural controller, which can be the same as a processing unit inside a mobile device. Neural network description can include a full specification of the neural network, including the neural architecture. For example, the neural network description can include a description or specification of architecture of the neural network (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc. and so forth.

The neural network can reflect the architecture defined in neural network description. In this non-limiting example, the neural network includes an input layer, which includes input data, which can be any type of data such as media content (images, videos, etc.), numbers, text, etc., associated with the corresponding input data described above with reference to FIGS. 1-2. In one illustrative example, the input layer can process data representing a portion of the input media data, such as a patch of data or pixels (e.g., a 128×128 patch of data) in an image corresponding to the input media data.

The neural network can include one or more hidden layers. The hidden layers can include n number of hidden layers, where n is an integer greater than or equal to one. The number of hidden layers can include as many layers as needed for a desired processing outcome and/or rendering intent. The neural network further includes an output layer that provides an output resulting from the processing performed by the hidden layers.

The neural network, in this example, is a multi-layer neural network of interconnected nodes. Each node can represent a piece of information. Information associated with the nodes is shared among the different layers and each layer retains information as information is processed. In some cases, the neural network can include a feed-forward neural network, in which case there are no feedback connections where outputs of the neural network are fed back into itself. In other cases, the neural network can include a recurrent neural network, which can have loops that allow information to be carried across nodes while reading in input.

Information can be exchanged between nodes through node-to-node interconnections between the various layers. Nodes of input layer can activate a set of nodes in the first hidden layer. For example, as shown, each input node of input layer is connected to each node of first hidden layer. Nodes of hidden layer can transform the information of each input node by applying activation functions to the information. The information derived from the transformation can then be passed to and can activate the nodes of the next hidden layer, which can perform their own designated functions. Example functions include convolutional, up-sampling, data transformation, pooling, and/or any other suitable functions. The output of hidden layer (e.g.) can then activate nodes of the next hidden layer, and so on. The output of last hidden layer can activate one or more nodes of output layer, at which point an output is provided. In some cases, while nodes in the neural network are shown as having multiple output lines, a node has a single output and all lines shown as being output from a node represent the same output value.

In some cases, each node or interconnection between nodes can have a weight that is a set of parameters derived from training the neural network. For example, an interconnection between nodes can represent a piece of information learned about the interconnected nodes. The interconnection can have a numeric weight that can be tuned (e.g., based on a training dataset), allowing the neural network to be adaptive to inputs and able to learn as more data is processed.

In some instances, the neural network is pre-trained to process the features from the data in the input layer using different hidden layers in order to provide the output through the output layer.

The neural network can include any suitable neural or deep learning type of network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network can represent any other neural or deep learning network, such as an autoencoder, a deep belief nets (DBNs), a recurrent neural networks (RNNs), etc.

Neural Architecture Search (NAS) involves a process in which neural controller searches through various types of neural networks such as CNNs, DBNs, RNNs, etc., to determine which type of neural network, given the input/output description of neural network description, can perform closes to the desired output once trained. This search process is currently cumbersome and resource intensive, because every type of available neural network is treated as a “blackbox.” In other words, a neural controller such as neural controller selects an available neural network (a blackbox), trains it, validates it and either selects it or not depending on the validation result. However, each available example or type of neural network is a collection of nodes. As will be described below, the present disclosure enables gaining insight into performance of each individual node to assess its performance, which then allows the system to select of a hybrid structure of nodes that may or may not be the same as a given particular structure of a neural network currently available. In other words, the present disclosure enables an AutoML system to pick and choose nodes from different available neural networks and create a new structure that performs best for a given application.

### 4. Convolutional Neural Networks

In another example, the multilabel hallucination-detection model 306 can be a convolutional neural network (CNN). The CNN accesses a matrix of multilingual embeddings (hereinafter referred to as an “embedding matrix”) and applies a series of operations which form a single convolutional layer: (1) convolution; (2) batch normalization; and (3) max-pooling. To perform convolution, the CNN applies one or more filters including a matrix of values that can “slide over” the embedding matrix so as to generate a set of feature maps. A filter includes a matrix of numbers that are different from a matrix of values of another filter, in order to allow the filter to extract different features from the embedding matrix. In some instances, a set of hyperparameters that correspond to the feature map generation are predefined (e.g., based on manual input). Feature-extraction hyperparameters may identify (for example) a number of filters, a stride for each filter (e.g., 1-step, 2-step), a padding size, a kernel size, and/or a kernel shape. For example, the CNN applies 128 filters, each of which having a kernel size of 5. As a result, 128 feature maps are generated for the text segment.

The CNN can perform a batch normalization operation on the set of feature maps to generate a set of normalized feature maps. As used herein, batch normalization is a supervised learning technique that normalizes interlayer outputs (e.g., the set of feature maps) of a neural network into a standard format. Batch normalization effectively ‘resets’ a distribution of the output of the previous layer to be more efficiently processed by the subsequent layer.

After the batch normalization operation, the CNN performs a pooling operation on the set of normalized feature maps in order to reduce the spatial size of each feature map and subsequently generate a set of pooled feature maps. In some embodiments, the CNN performs the pooling operation to reduce dimensionality of the set of normalized feature maps, while retaining the semantic features captured by the embedding matrix. In some instances, the CNN system performs a max pooling operation to access a group of values within the feature map (e.g., 2 values within the feature map) and selects an element associated with the highest value. This operation can be iterated to traverse the entirety of each feature map of the set of normalized feature maps, at which the max pooling operation completes the generation of the set of pooled feature maps. For example, the CNN sets a pool size of 2 and reduces dimensions for each feature map of the set of normalized feature maps (“128”) by half (“64”). As a result, a dimensionality for each pooled feature map is 64.

The CNN system may alternatively or additionally perform an average pooling operation in place of the max pooling operation which selects the sum or average value of the elements captured in the area within the feature map. By performing the pooling operations, the CNN system may achieve several technical advantages including capability of generating an input representation of the embedding matrix that allows reduction of number of parameters and computations within the CNN model.

The CNN can continue to apply one or more additional convolutional layers at which convolution and pooling operations are performed on the set of pooled feature maps. For example, the CNN generates a second set of feature maps by applying another set of filters to each feature map of the set of pooled feature maps. In addition, the CNN applies a global max pooling operation on the second set of feature maps such that a maximum value for each feature map is selected to form a second set of pooled feature maps.

The CNN applies a fully connected layer (alternatively, a dense layer) to the second set of pooled feature maps to generate a feature representation of the text segment of the input data. The fully connected layer includes a multi-layer perceptron network incorporating a softmax activation function or other types of linear or non-linear functions at an output layer. In some instances, the CNN uses the fully connected layer that accesses the extracted features and generates an output that includes a feature representation that identifies one or more semantic characteristics of the text segment. For example, the feature representation of the text segment is an array of values having an array size of 64. In some instances, the CNN performs the above operations through the remaining text segments represented by the multilingual embeddings, thereby generating feature representations that represent the multilingual embeddings.

The feature representations can then be used as an input for an output layer, which then performs a series of operations for generating an output associated with a given NLP task. In some instances, the output and the labels of the training dataset are used as input for loss functions to optimize the parameters in the CNN. An error value generated by the loss functions is used in backpropagation algorithms to adjust the parameters in the CNN and thus improve the accuracy of subsequent feature representations outputted by the CNN.

It will be appreciated that a different number of convolutional layers may be used (e.g., which may have an effect of repeating these operations can be repeated by the CNN system one or more times). In some instances, pooling operations are omitted for one or more convolutional layers applied by the CNN system. Different versions of the CNN architecture can be used by the CNN system, including but not limited to AlexNet, ZF Net, GoogLeNet, VGGNet, ResNets, DenseNet, etc.

### 5. Other Machine-Learning Models

In addition to the above models, the multilabel hallucination-detection model 306 can include any type of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like.

### B. Data Preparation

Once the multilabel hallucination-detection model 306 is selected, the training subsystem 304 can train the multilabel hallucination-detection model 306 using a training dataset accessed from a training database 310. Various training and test data sets may be utilized to train the machine-learning model such that once trained, the multilabel hallucination-detection model 306 can detect hallucination in machine-generated responses that were generated by LLMs. In some instances, the training dataset can include previous machine-generated responses annotated with the set of classification labels.

### 1. Data Procurement

In some instances, the training data includes a combination of open source data and production customer service data across different domains. To obtain the production data of the training dataset, historical conversations can be queried, such as querying for the historical conversations included the customer service brand LLM suggestions in a RAG setting. The production data include data generated from GPT-3.5-turbo. In order to obtain more variation in LLM responses and use those responses for training the hallucination-detection model, we prompted Xwin-LM-70b, llama2-70b-chat, falcon-7b-instruct, and llama2-13b to respond as the AI Assistant in the historical conversations. The historical brand conversation along with retrieved articles and the generated LLM responses were span-annotated by 3 domain expert annotators. Annotators were instructed to annotate sentences according to the taxonomy described in Table 1, and to skip any incomplete sentences that may have arisen due to LLM token limits. Across different brand production data, the average fleiss-kappa (Bird and Klein, 1971) for inter-annotator agreement was 0.78 (CHANGE/VERIFY), indicating substantial agreement.

In addition to annotating production brand data, we also filtered and annotated subsets of data from TruthfulQA and Dolly. We filtered the original TruthfulQA dataset of 817 unique responses to a set of 206 questions based on: (a) our ability to retrieve the related Wikipedia articles; and (b) examples within the 2048 token limit that most LLMs are restricted to. The resulting dataset included 206 unique questions, their related Wikipedia articles, and a list of responses to the question. For Dolly, the data was procured as follows. First, we sampled from the “closed_qa” portion of the Dolly dataset. This data was generated by crowd workers who were given a context and instructed to generate questions and answers based on that context. To generate examples of hallucination, we split each response into individual sentences. Then we made each sentence an example of a hallucination by altering the context so that it either contradicts the answer or it does not contain the answer.

### 2. Classification Labels

Due to the risks associated with model hallucinations in industry settings, the classification labels use the definition of SUPPORTED/UNSUPPORTED statements as described in Table 1 of Section 1. Unlike other annotations in training datasets such as ExpertQA and TruthfulQA datasets, we consider world knowledge to be UNSUPPORTED relative to the retrieved knowledge source. In addition, the taxonomy used herein does not overlap factually verifiable statements (VERIFIABLE) and non-verifiable (NO-INFO) statements. VERIFIABLE statements can include both SUPPORTED and UNSUPPORTED claims.

For example, each of the previous machine-generated responses can be associated with a corresponding classification label indicating whether the previous response contradicts the knowledge base. The set of classification labels for the single hallucination-detection model can include: (i) a no-info classification label indicating that the corresponding machine-generated response includes non-verifiable information; (ii) a supported classification label indicating that the corresponding machine-generated response is supported by the knowledge base; and (iii) an unsupported classification label indicating that the corresponding machine-generated response contradicts the at least part of the knowledge base.

A large pool of data accessed from the training database 310 may be split into two classes of data called training data set and test data set. For example, 80% of the accessed data from the pool may be used as part of the training data set while the remaining 20% of the accessed data from the pool may be used as part of the test data set. The test-train splits for open source data involved a random stratified split across classification labels. All production data used also involved a random 80/20 split for train and testing. In some instances, a small percentage of the training data set (e.g., 2%) is used for evaluation of the hallucination-detection model. The percentages according to which the pool of the data are split into training data set and test data set is not limited to 80/20 and may be set according to a configurable accuracy requirement and/or error tolerance (e.g., the split can be 50/50, 60/40, 70/30, 80/20, 90/10, etc. between the two data sets).

### C. Training

The training subsystem 304 can then use the training dataset to train the multilabel hallucination-detection model 306 by calculating a loss based on a comparison between an output generated from the hallucination-detection model and a corresponding classification label of the training data. With each output generated by the multilabel hallucination-detection model 306 (e.g., an observed classification label corresponding to the previous machine-generated response), the training classification label can be used to correct the output of the multilabel hallucination-detection model 306. In some instances, manual feedback is further utilized to adjust the corresponding parameters of the hallucination-detection model. As noted, weights of different nodes of the multilabel hallucination-detection model 306 may be adjusted/tuned during the training process to improve resulting output.

During training, weights of nodes associated with the multilabel hallucination-detection model 306 can be adjusted using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training media data until the weights of the layers are accurately tuned. In particular, the training of the multilabel hallucination-detection model 306 (e.g., adjustment of the weights) can be performed until a corresponding loss (e.g., a mean square error) reaches a minimum threshold.

Once trained, the training subsystem 304 can test the multilabel hallucination-detection model 306 using the test data set. Examples of testing methods can include regression testing, unit testing, beta testing, and alpha testing. Once the result of testing the multilabel hallucination-detection model 306 is satisfactory (e.g., when outputs of the testing stage is greater than or equal to a threshold or incorrect detections are less than a threshold), the training subsystem 304 can deploy the trained multilabel hallucination-detection model 306 to a hallucination-detection system 320, which can use the trained multilabel hallucination-detection model 306 to generate prompts for the customized content.

### D. Deployment

After accessing the trained multilabel hallucination-detection model 306, a hallucination-detection system 320 can proceed with a deployment phase 312, in which the hallucination-detection system 320 applies the trained multilabel hallucination-detection model 306 to input data to detect hallucination in machine-generated responses (e.g., generate classification labels indicating whether the machine-generated responses contradict the external knowledge base).

The input data for the trained machine-learning model can include text data 314. The text data 314 can include machine-generated responses 316 initially generated by a generative machine-learning model (e.g., the LLM) in response to a prompt submitted by a user. In some instances, the machine-generated responses 316 are supplemented by outputs generated by a RAG system. To generate the abovementioned outputs, the RAG system can access a knowledge base stored in database server. In some instances, the knowledge base includes domain-specific information, which can be associated with a particular domain. Examples of domains can include real property, cybersecurity, fintech, telecom, healthcare, finance, energy, media and entertainment, pharmaceuticals, consumer goods (e.g., sporting goods), and environment.

An encoding module 318 can then encode the text data 314 to generate a set of embeddings or feature vectors. The embedding can include a set of values (e.g., a numerical array) that represent the input data, in which the embedding can be used as input to the multilabel hallucination-detection model 306. Example techniques for generating the embeddings can include term frequency-inverse document frequency (TF-IDF) techniques, word-embedding techniques, and tokenization techniques.

The hallucination-detection system 320 can then apply the trained multilabel hallucination-detection model 306 (e.g., the neural network) to the embedding to generate classification labels 322 that indicate whether the machine-learning responses contradict at least part of the knowledge base. The classification labels 322 that include: (i) a no-info classification label 324 indicating that the corresponding machine-generated response includes non-verifiable information; (ii) a supported classification label 326 indicating that the corresponding machine-generated response is supported by the knowledge base; and (iii) an unsupported classification label 328 indicating that the corresponding machine-generated response contradicts the at least part of the knowledge base.

The hallucination-detection system can the annotate the text data with corresponding classification labels 322, which can be used to efficiently identify factually unverifiable information from the machine-generated responses. For example, the annotated text data can be displayed in on a graphical user interface, as messages are exchanged between the user and an agent during an instant-chat session.

### III. Two-Tiered Binary Hallucination-Detection Models for Detecting Hallucination in Machine-Generated Responses

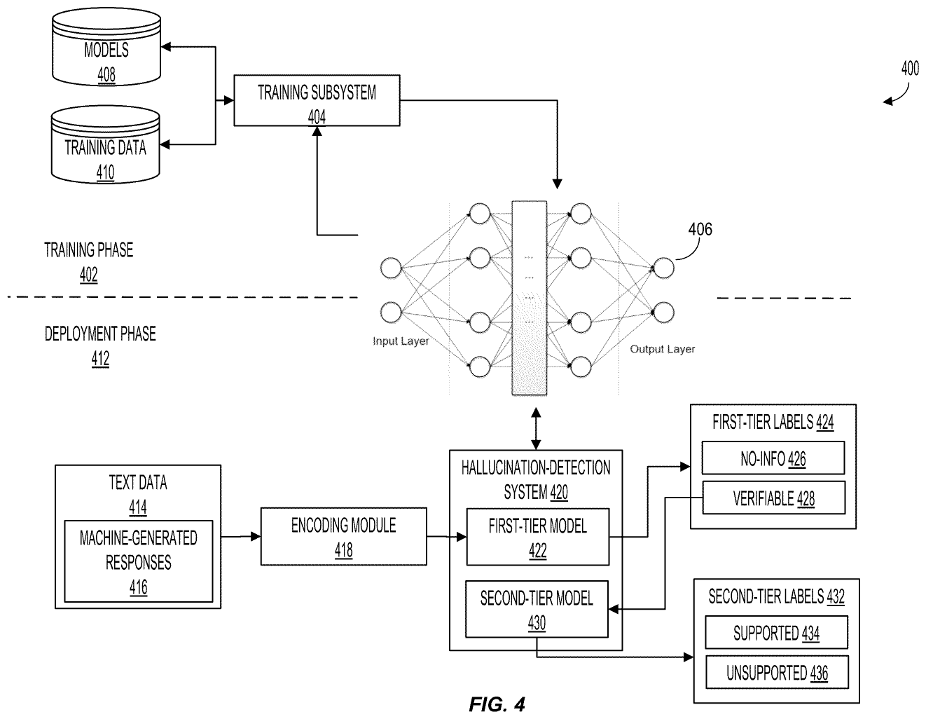

FIG. 4 illustrates an example schematic diagram 400 for training and deploying a two-tiered binary hallucination-detection models for detecting hallucination in machine-generated responses, according to some embodiments.

### A. Model Selection

As shown in FIG. 4, the machine-learning techniques for detecting hallucination in machine-generated responses can include training two-tiered binary hallucination-detection models to generate classification labels that indicate whether a given machine-generated response contradicts an external knowledge base. A training phase 402 can be initiated by a training subsystem 404 accessing initial two-tiered binary hallucination-detection models 406 from a models database 408. In some instances, the two-tiered binary hallucination-detection models 406 can include a pretrained Decoding-enhanced Bidirectional Encoder Representations from Transformers with Disentangled attention (DeBERTa) model and/or a pretrained LLM.

### 1. Pretrained Decoder LLM

LLMs have been recognized for their learned world knowledge and large token limits (CITE). Because grounding context for hallucination detection can widely vary in length, fine-tuned LLMs can be used as an encoder-based solution for detecting hallucinations in machine-generated responses. For example, Mistral-7b-Instruct trained to classify one sentence at a time was fine-tuned. In the context of RAG, the model was given the input prompt including the user's question, retrieved KBs, and a sentence from the LLM Response (the statement being classified for factual consistency). These information were used to train the model to produce one of the labels from the taxonomy described in Table 1.

The mistral model was fine-tuned using Deepspeed Zero Stage 1 optimization (Samyam Rajbhandari, 2020), batch size of 1, gradient accumulation steps of 4, floating point 16 precision, a learning rate of 5e-6, and 4 epochs. The maximum token limit for this model is 2048.

### 2. DeBERTa Model

The DeBERTa model is a type of machine-learning model that improves from previous BERT and RoBERTa models by implementing two distinguishing features: (i) a disentangled attention mechanism; and (ii) an enhanced masked decoder. The BERT model represents each word by a single vector, which can be computed by the sum of its word embedding and an absolute position embedding. In contrast, DeBERTa separates or disentangles these embeddings into two different vectors, thereby representing each word by two vectors. The attention weights can be computed using disentangled matrices on their word and relative position. The reason behind this approach is that the attention weight of a word pair not only depends on the content of the words but also on their relative position. For example, consider the words “deep” and “learning”. Their dependency is much stronger when their position to each other is smaller than when their position to each other is larger.

Enhanced mask decoder BERT uses masked language modelling (MLM). This is a fill-in-the-blank task, where the model learns to predict what word a token should mask, based on its context, i.e., the words surrounding the mask token. DeBERTa also uses MLM while pre-training. Their disentangled attention mechanism already considers the contents and relative positions of the context words but not their absolute positions. The absolute positions are in many cases crucial and can help the model learn syntactical nuances which would not be tangible if it only considered the relative position. Consider this example:
“a new store opened beside the new mall”
“a new <mask1> opened beside the new <mask2>”
   The masked tokens “store” and “mall” have a similar context, but store is the subject and mall is the object. These syntactical nuances can only be learned by considering the absolute position of the masked tokens. DeBERTa can incorporate these absolute word embeddings before the Softmax layer, right before the model decodes the masked words based on the contextual embedding (word contents and positions). Accordingly, the DeBERTa model can combine the relative and absolute position to exceed the results of previous models.

The DeBERTa encoder models can thus be selected for detecting hallucination for several reasons. First, from an industry practicality standpoint, the DeBERTa models are substantially smaller and faster than other machine-learning models. Further, encoders are known to be more powerful than decoder-only models because they encode relative context both in front of and behind each token. While the LLMs are often preferred for their high token limits, the relative position embeddings of the DeBERTa encoder model allows for a theoretical maximum token limit of 24,528 (Pengcheng He, 2021).

### 3. Artificial Neural Networks

In another example, the two-tiered binary hallucination-detection models 406 can include two or more machine-learning models, including an artificial neural network selected from the models database 408. The neural network can be defined by an example neural network description for machine learning in a neural controller, which can be the same as a processing unit inside a mobile device. Neural network description can include a full specification of the neural network, including the neural architecture. For example, the neural network description can include a description or specification of architecture of the neural network (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc. and so forth.

The neural network can reflect the architecture defined in neural network description. In this non-limiting example, the neural network includes an input layer, which includes input data, which can be any type of data such as media content (images, videos, etc.), numbers, text, etc., associated with the corresponding input data described above with reference to FIGS. 1-2. In one illustrative example, the input layer can process data representing a portion of the input media data, such as a patch of data or pixels (e.g., a 128×128 patch of data) in an image corresponding to the input media data.

The neural network can include one or more hidden layers. The hidden layers can include n number of hidden layers, where n is an integer greater than or equal to one. The number of hidden layers can include as many layers as needed for a desired processing outcome and/or rendering intent. The neural network further includes an output layer that provides an output resulting from the processing performed by the hidden layers.

The neural network, in this example, is a multi-layer neural network of interconnected nodes. Each node can represent a piece of information. Information associated with the nodes is shared among the different layers and each layer retains information as information is processed. In some cases, the neural network can include a feed-forward neural network, in which case there are no feedback connections where outputs of the neural network are fed back into itself. In other cases, the neural network can include a recurrent neural network, which can have loops that allow information to be carried across nodes while reading in input.

Information can be exchanged between nodes through node-to-node interconnections between the various layers. Nodes of input layer can activate a set of nodes in the first hidden layer. For example, as shown, each input node of input layer is connected to each node of first hidden layer. Nodes of hidden layer can transform the information of each input node by applying activation functions to the information. The information derived from the transformation can then be passed to and can activate the nodes of the next hidden layer, which can perform their own designated functions. Example functions include convolutional, up-sampling, data transformation, pooling, and/or any other suitable functions. The output of hidden layer (e.g.) can then activate nodes of the next hidden layer, and so on. The output of last hidden layer can activate one or more nodes of output layer, at which point an output is provided. In some cases, while nodes in the neural network are shown as having multiple output lines, a node has a single output and all lines shown as being output from a node represent the same output value.

In some cases, each node or interconnection between nodes can have a weight that is a set of parameters derived from training the neural network. For example, an interconnection between nodes can represent a piece of information learned about the interconnected nodes. The interconnection can have a numeric weight that can be tuned (e.g., based on a training dataset), allowing the neural network to be adaptive to inputs and able to learn as more data is processed.

In some instances, the neural network is pre-trained to process the features from the data in the input layer using different hidden layers in order to provide the output through the output layer.

The neural network can include any suitable neural or deep learning type of network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network can represent any other neural or deep learning network, such as an autoencoder, a deep belief nets (DBNs), a recurrent neural networks (RNNs), etc.

Neural Architecture Search (NAS) involves a process in which neural controller searches through various types of neural networks such as CNNs, DBNs, RNNs, etc., to determine which type of neural network, given the input/output description of neural network description, can perform closes to the desired output once trained. This search process is currently cumbersome and resource intensive, because every type of available neural network is treated as a “blackbox.” In other words, a neural controller such as neural controller selects an available neural network (a blackbox), trains it, validates it and either selects it or not depending on the validation result. However, each available example or type of neural network is a collection of nodes. As will be described below, the present disclosure enables gaining insight into performance of each individual node to assess its performance, which then allows the system to select of a hybrid structure of nodes that may or may not be the same as a given particular structure of a neural network currently available. In other words, the present disclosure enables an AutoML system to pick and choose nodes from different available neural networks and create a new structure that performs best for a given application.

### 4. Convolutional Neural Networks

In another example, the two-tiered binary hallucination-detection models 406 can include two or more machine-learning models, including a convolutional neural network (CNN). The CNN accesses a matrix of multilingual embeddings (hereinafter referred to as an “embedding matrix”) and applies a series of operations which form a single convolutional layer: (1) convolution; (2) batch normalization; and (3) max-pooling. To perform convolution, the CNN applies one or more filters including a matrix of values that can “slide over” the embedding matrix so as to generate a set of feature maps. A filter includes a matrix of numbers that are different from a matrix of values of another filter, in order to allow the filter to extract different features from the embedding matrix. In some instances, a set of hyperparameters that correspond to the feature map generation are predefined (e.g., based on manual input). Feature-extraction hyperparameters may identify (for example) a number of filters, a stride for each filter (e.g., 1-step, 2-step), a padding size, a kernel size, and/or a kernel shape. For example, the CNN applies 128 filters, each of which having a kernel size of 5. As a result, 128 feature maps are generated for the text segment.

The CNN can perform a batch normalization operation on the set of feature maps to generate a set of normalized feature maps. As used herein, batch normalization is a supervised learning technique that normalizes interlayer outputs (e.g., the set of feature maps) of a neural network into a standard format. Batch normalization effectively ‘resets’ a distribution of the output of the previous layer to be more efficiently processed by the subsequent layer.

After the batch normalization operation, the CNN performs a pooling operation on the set of normalized feature maps in order to reduce the spatial size of each feature map and subsequently generate a set of pooled feature maps. In some embodiments, the CNN performs the pooling operation to reduce dimensionality of the set of normalized feature maps, while retaining the semantic features captured by the embedding matrix. In some instances, the CNN system performs a max pooling operation to access a group of values within the feature map (e.g., 2 values within the feature map) and selects an element associated with the highest value. This operation can be iterated to traverse the entirety of each feature map of the set of normalized feature maps, at which the max pooling operation completes the generation of the set of pooled feature maps. For example, the CNN sets a pool size of 2 and reduces dimensions for each feature map of the set of normalized feature maps (“128”) by half (“64”). As a result, a dimensionality for each pooled feature map is 64.

The CNN system may alternatively or additionally perform an average pooling operation in place of the max pooling operation which selects the sum or average value of the elements captured in the area within the feature map. By performing the pooling operations, the CNN system may achieve several technical advantages including capability of generating an input representation of the embedding matrix that allows reduction of number of parameters and computations within the CNN model.

The CNN can continue to apply one or more additional convolutional layers at which convolution and pooling operations are performed on the set of pooled feature maps. For example, the CNN generates a second set of feature maps by applying another set of filters to each feature map of the set of pooled feature maps. In addition, the CNN applies a global max pooling operation on the second set of feature maps such that a maximum value for each feature map is selected to form a second set of pooled feature maps.

The CNN applies a fully connected layer (alternatively, a dense layer) to the second set of pooled feature maps to generate a feature representation of the text segment of the input data. The fully connected layer includes a multi-layer perceptron network incorporating a softmax activation function or other types of linear or non-linear functions at an output layer. In some instances, the CNN uses the fully connected layer that accesses the extracted features and generates an output that includes a feature representation that identifies one or more semantic characteristics of the text segment. For example, the feature representation of the text segment is an array of values having an array size of 64. In some instances, the CNN performs the above operations through the remaining text segments represented by the multilingual embeddings, thereby generating feature representations that represent the multilingual embeddings.

The feature representations can then be used as an input for an output layer, which then performs a series of operations for generating an output associated with a given NLP task. In some instances, the output and the labels of the training dataset are used as input for loss functions to optimize the parameters in the CNN. An error value generated by the loss functions is used in backpropagation algorithms to adjust the parameters in the CNN and thus improve the accuracy of subsequent feature representations outputted by the CNN.

It will be appreciated that a different number of convolutional layers may be used (e.g., which may have an effect of repeating these operations can be repeated by the CNN system one or more times). In some instances, pooling operations are omitted for one or more convolutional layers applied by the CNN system. Different versions of the CNN architecture can be used by the CNN system, including but not limited to AlexNet, ZF Net, GoogLeNet, VGGNet, ResNets, DenseNet, etc.

### 5. Other Machine-Learning Models

In addition to the above models, the two-tiered binary hallucination-detection models 406 can include any type of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like.

### B. Data Preparation

Once the two-tiered binary hallucination-detection models 406 are selected, the training subsystem 404 can train the two-tiered binary hallucination-detection models 406 using a training dataset accessed from a training database 410. Various training and test data sets may be utilized to train the machine-learning model such that once trained, the two-tiered binary hallucination-detection models 406 can detect hallucination in machine-generated responses that were generated by LLMs. In some instances, the training dataset can include previous machine-generated responses annotated with the set of classification labels. For example, each of the previous machine-generated responses can be associated with a corresponding classification label indicating whether the previous response contradicts the knowledge base.

### 1. Data Procurement

In some instances, the training data includes a combination of open source data and production customer service data across different domains. To obtain the production data of the training dataset, historical conversations were queried, in which the historical conversations included the customer service brand LLM suggestions in a RAG setting. The production data include data generated from GPT-3.5-turbo. In order to obtain more variation in LLM responses and use those responses for training the hallucination-detection model, we prompted Xwin-LM-70b, llama2-70b-chat, falcon-7b-instruct, and llama2-13b to respond as the AI Assistant in the historical conversations. The historical brand conversation along with retrieved articles and the generated LLM responses were span-annotated by 3 domain expert annotators. Annotators were instructed to annotate sentences according to the taxonomy described in Table 1, and to skip any incomplete sentences that may have arisen due to LLM token limits. Across different brand production data, the average fleiss-kappa (Bird and Klein, 1971) for inter-annotator agreement was 0.78 (CHANGE/VERIFY), indicating substantial agreement.

In addition to annotating production brand data, we also filtered and annotated subsets of data from TruthfulQA and Dolly. We filtered the original TruthfulQA dataset of 817 unique responses to a set of 206 questions based on: (a) our ability to retrieve the related Wikipedia articles; and (b) examples within the 2048 token limit that most LLMs are restricted to. The resulting dataset included 206 unique questions, their related Wikipedia articles, and a list of responses to the question. For Dolly, the data was procured as follows. First, we sampled from the “closed_qa” portion of the Dolly dataset. This data was generated by crowd workers who were given a context and instructed to generate questions and answers based on that context. To generate examples of hallucination, we split each response into individual sentences. Then we made each sentence an example of a hallucination by altering the context so that it either contradicts the answer or it does not contain the answer.

### 2. Classification Labels

Similar to the classification labels described in Section II, the classification labels use the definition of SUPPORTED/UNSUPPORTED statements as described in Table 1 of Section 1. Unlike other annotations in training datasets such as ExpertQA and TruthfulQA datasets, we consider world knowledge to be UNSUPPORTED relative to the retrieved knowledge source. In addition, the taxonomy used herein does not overlap factually verifiable statements (VERIFIABLE) and non-verifiable (NO-INFO) statements. VERIFIABLE statements can include both SUPPORTED and UNSUPPORTED claims.

Each of the two-tiered binary hallucination-detection models can be trained with different training datasets. For example, a first hallucination-detection model can be trained using a first training data that includes previous machine-generated responses annotated with a first set of classification labels. The first set of classification labels are configured to indicate whether the previous machine-generated responses include information verifiable from the knowledge base (e.g., a “verifiable” classification label, a “no-info” classification label). In addition, a second hallucination-detection model can be trained using a second training data set that includes previous machine-generated responses annotated with a second set of classification labels. The second set of classification labels are configured to indicate whether the corresponding machine-generated response contradicts at least part of the knowledge base (e.g., a “supported” classification label, an “unsupported” classification label). Example definitions of the classification labels are described in Section I, Table 1 of the present disclosure.

A large pool of data accessed from the training database 310 may be split into two classes of data called training data set and test data set. For example, 80% of the accessed data from the pool may be used as part of the training data set while the remaining 20% of the accessed data from the pool may be used as part of the test data set. The test-train splits for open source data involved a random stratified split across classification labels. All production data used also involved a random 80/20 split for train and testing. In some instances, a small percentage of the training data set (e.g., 2%) is used for evaluation of the hallucination-detection model. The percentages according to which the pool of the data are split into training data set and test data set is not limited to 80/20 and may be set according to a configurable accuracy requirement and/or error tolerance (e.g., the split can be 50/50, 60/40, 70/30, 80/20, 90/10, etc. between the two data sets).

### C. Training

The training subsystem 404 can then use the first and second training datasets to train the two-tiered binary hallucination-detection models 406. The training can include calculating a loss based on a comparison between an output generated from the hallucination-detection model and a corresponding classification label of the training data. With each output generated by one of the two-tiered binary hallucination-detection models 406 (e.g., an observed classification label corresponding to the previous machine-generated response), the training classification label can be used to correct the output of the corresponding two-tiered binary hallucination-detection model. In some instances, manual feedback is further utilized to adjust the corresponding parameters of the hallucination-detection model. As noted, weights of different nodes of the two-tiered binary hallucination-detection models 406 may be adjusted/tuned during the training process to improve resulting output.

During training, weights of nodes associated with the two-tiered binary hallucination-detection models 406 can be adjusted using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training media data until the weights of the layers are accurately tuned. In particular, the training of the two-tiered binary hallucination-detection models 406 (e.g., adjustment of the weights) can be performed until a corresponding loss (e.g., a mean square error) reaches a minimum threshold.

Once trained, the training subsystem 404 can test the two-tiered binary hallucination-detection models 406 using the test data set. Examples of testing methods can include regression testing, unit testing, beta testing, and alpha testing. Once the result of testing the two-tiered binary hallucination-detection models 406 is satisfactory (e.g., when outputs of the testing stage is greater than or equal to a threshold or incorrect detections are less than a threshold), the training subsystem 404 can deploy the trained two-tiered binary hallucination-detection models 406 to a hallucination-detection system 420, which can use the trained two-tiered binary hallucination-detection models 406 to generate prompts for the customized content.

### D. Deployment

After accessing the trained two-tiered binary hallucination-detection models 406, a hallucination-detection system 420 can proceed with a deployment phase 412, in which the hallucination-detection system 420 applies the trained two-tiered binary hallucination-detection models 406 to input data to detect hallucination in machine-generated responses (e.g., generate classification labels indicating whether the machine-generated responses contradict the external knowledge base).

The input data for the trained machine-learning model can include text data 414. The text data 414 can include machine-generated responses 416 initially generated by a generative machine-learning model (e.g., the LLM) in response to a prompt submitted by a user. In some instances, the machine-generated responses 416 are supplemented by outputs generated by a RAG system. To generate the abovementioned outputs, the RAG system can access a knowledge base stored in database server. In some instances, the knowledge base includes domain-specific information, which can be associated with a particular domain. Examples of domains can include real property, cybersecurity, fintech, telecom, healthcare, finance, energy, media and entertainment, pharmaceuticals, consumer goods (e.g., sporting goods), and environment.

An encoding module 418 can then encode the text data 414 to generate a set of embeddings or feature vectors. The embedding can include a set of values (e.g., a numerical array) that represent the input data, in which the embedding can be used as input to the two-tiered binary hallucination-detection models 406. Example techniques for generating the embeddings can include term frequency-inverse document frequency (TF-IDF) techniques, word-embedding techniques, and tokenization techniques.

The hallucination-detection system 420 can sequentially apply the trained two-tiered binary hallucination-detection models 406 (e.g., the neural network) to the embedding to generate classification labels that indicate whether the machine-learning responses contradict at least part of the knowledge base. For example, a first hallucination-detection model 422 generates a set of first-tier classification labels 424 indicating whether the corresponding machine-generated response includes information verifiable from the knowledge base. The first-tier classification labels 424 can include: (i) a no-info classification label 426 indicating that the corresponding machine-generated response includes non-verifiable information; and (ii) a verifiable classification label 428 indicating that the corresponding machine-generated response includes verifiable information.

For machine-generated responses associated with the verifiable classification labels 428, a second hallucination-detection model can be subsequently applied to said machine-generated responses to generate a set of second-tier classification labels 432. The second-tier classification labels 432 can include: (i) a supported classification label 432 indicating that the corresponding machine-generated response is supported by the knowledge base; and (iii) an unsupported classification label 436 indicating that the corresponding machine-generated response contradicts the at least part of the knowledge base. As a result, three types of classification labels 426, 434, and 436 can be generated for annotating the machine-generated responses.

The hallucination-detection system can the annotate the text data with the no-info classification labels 426, the supported classification labels 434 and the unsupported classification labels 436. These classification labels can be used to efficiently identify factually unverifiable information from the machine-generated responses. For example, the annotated text data can be displayed in on a graphical user interface, as messages are exchanged between the user and an agent during an instant-chat session.

### IV. Evaluating and Refining Hallucination-Detection Models

In some embodiments, the quality of the hallucination-detection models is evaluated using curated test sets during the development process. The evaluation process can ensure that desired performance metrics can be attained. However, these evaluation metrics are not static and it is not uncommon in general for deployed models to have degrading performance over time due to issues like data drift. In order to ensure that we are continually providing the best performing models, the performance of the hallucination-detection models can be monitored on live production data and evaluate whether the model's performance continues to be within a target range.

The evaluation process described herein can include a framework that can be applied to any number of machine-learning models (e.g., the hallucination-detection model) deployed into production. In some instances, the framework can include three different stages: (i) data preparation; (ii) data labeling; and (iii) model updating. The framework establishes a pipeline that can be repeated on a cyclical basis (e.g., every quarter) to ensure that the corresponding models are performing consistently with satisfactory metrics and are not experiencing degradation in performance due to factors such as data drift.

The process can include modular components (e.g., preprocessing, evaluation, error analysis, etc.), which can be modified such that they are relevant to the target model being audited. The models can then be evaluated on new data for each cycle to ensure that not only are they are performing within an acceptable range relative to the original evaluation metrics from the development stage, but also that they can generalize to either more recent data or data from brand domains that the model has not previously been evaluated on.

### A. Data Preparation

The data preparation stage can include querying and preprocessing of data to prepare for later processing stages, including model inference and annotation. The first part of data preparation includes query an initial data. The initial data can be modified based a type of machine-learning model is being evaluated. For example, hallucination-detection models can be trained on data from multiple brand domains and are configured to be applied to data associated with various domains.

When applying the evaluation framework to subject models, the queried data can be retrieved from domains that were not in the original training process (or in the last freshness cycle). Using data from other domains can ensure that the subject model continues to be applicable to a wide range of brands and verticals. In an event that a given hallucination-detection model is trained to be domain-specific, the corresponding queried data can be retrieved from the same domain, but exclusively from the range of dates since either the original development phase or the last freshness audit.

After the querying stage, the data can be preprocessed for the labeling stage. These preprocessing steps can include operations applicable to different types of machine-learning models, including rich content conversion and personally-identifiable information (PII) masking. In some instances, one or more aspects of the preprocessing steps can be modified to be specific for each individual model.

### B. Data Labeling

The data labeling stage can include two substages that work in parallel with each other. A first substage can include generating annotations for the target models that are being evaluated. In some instances, some models (e.g., FCR) have an automatic labeling capability in which the label can easily be deduced from information within the conversation and requires no human annotation. Other types of machine-learning models (e.g., hallucination-detection models) can require manual annotations, such as manually labeling the data with the correct labels. A second substage of the labeling process can include passing the preprocessed data through the target model to collect its predictions and/or classifications which will be compared to the ground-truth labels in the evaluation process.

### C. Model Evaluation and Updating

The model updating process also includes two stages. The first stage of the model updating process can include generating evaluation metrics for the model's performance on the labeled data. The evaluation strategies may be modified relative to the target model/task. For example, generating the evaluation metrics can include calculating the precision, recall, and F1 scores of the model for various labels and comparing them to the evaluated metrics calculated during the original training process. Once these metrics are obtained, it can be determined whether the subject machine-learning model is still performing satisfactorily and within expected performance.

If the evaluation metrics indicate that performance of the model (e.g., the hallucination-detection model) is within target performance ranges, no further action is performed and the deployed version of the subject model can proceed with deployment without further updates. Conversely, if the evaluation metrics indicate that the performance of the model has been found to be insufficient, various techniques can be implemented to perform error analysis that can facilitate the root cause(s) that are associated with performance degradation of the machine-learning model. Using results associated with the error analysis, an update strategy can be implemented, in which the update strategy can include generating a new training set that has an emphasis on improving identified deficiencies. Once the new model is trained and evaluated to the point of satisfactory performance, the new model can be deployed into production and provided to the users.

### V. Example Systems

FIG. 5 illustrates a computing system architecture 500, including various components in electrical communication with each other, in accordance with some embodiments. The example computing system architecture 500 illustrated in FIG. 5 includes a computing device 502, which has various components in electrical communication with each other using a connection 506, such as a bus, in accordance with some implementations. The example computing system architecture 500 includes a processing unit 504 that is in electrical communication with various system components, using the connection 506, and including the system memory 514. In some embodiments, the system memory 514 includes read-only memory (ROM), random-access memory (RAM), and other such memory technologies including, but not limited to, those described herein. In some embodiments, the example computing system architecture 500 includes a cache 508 of high-speed memory connected directly with, in close proximity to, or integrated as part of the processor 504. The system architecture 500 can copy data from the memory 514 and/or the storage device 510 to the cache 508 for quick access by the processor 504. In this way, the cache 508 can provide a performance boost that decreases or eliminates processor delays in the processor 504 due to waiting for data. Using modules, methods and services such as those described herein, the processor 504 can be configured to perform various actions. In some embodiments, the cache 508 may include multiple types of cache including, for example, level one (L1) and level two (L2) cache. The memory 514 may be referred to herein as system memory or computer system memory. The memory 514 may include, at various times, elements of an operating system, one or more applications, data associated with the operating system or the one or more applications, or other such data associated with the computing device 502.

Other system memory 514 can be available for use as well. The memory 514 can include multiple different types of memory with different performance characteristics. The processor 504 can include any general purpose processor and one or more hardware or software services, such as service 512 stored in storage device 510, configured to control the processor 504 as well as a special-purpose processor where software instructions are incorporated into the actual processor design. The processor 504 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 504 can be a microprocessor, a microcontroller, a digital signal processor (“DSP”), or a combination of these and/or other types of processors. In some embodiments, the processor 504 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 500, an input device 516 can represent any number of input mechanisms, such as a microphone for speech, a touch-sensitive screen for gesture or graphical input, keyboard, mouse, motion input, pen, and other such input devices. An output device 518 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 500. In some embodiments, the input device 516 and/or the output device 518 can be coupled to the computing device 502 using a remote connection device such as, for example, a communication interface such as the network interface 520 described herein. In such embodiments, the communication interface can govern and manage the input and output received from the attached input device 516 and/or output device 518. As may be contemplated, there is no restriction on operating on any particular hardware arrangement and accordingly the basic features here may easily be substituted for other hardware, software, or firmware arrangements as they are developed.

In some embodiments, the storage device 510 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 510 can include hardware and/or software services such as service 512 that can control or configure the processor 504 to perform one or more functions including, but not limited to, the methods, processes, functions, systems, and services described herein in various embodiments. In some embodiments, the hardware or software services can be implemented as modules. As illustrated in example computing system architecture 500, the storage device 510 can be connected to other parts of the computing device 502 using the system connection 506. In some embodiments, a hardware service or hardware module such as service 512, that performs a function can include a software component stored in a non-transitory computer-readable medium that, in connection with the necessary hardware components, such as the processor 504, connection 506, cache 508, storage device 510, memory 514, input device 516, output device 518, and so forth, can carry out the functions such as those described herein.

The disclosed systems and service of a hallucination-detection system (e.g., the hallucination-detection system described herein at least in connection with FIG. 1) can be performed using a computing system such as the example computing system illustrated in FIG. 5, using one or more components of the example computing system architecture 500. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for detecting hallucination in machine-generated responses described herein by, for example, executing code using a processor such as processor 504 wherein the code is stored in memory such as memory 514 as described herein. One or more of a user device, a provider server or system, a database system, or other such devices, services, or systems may include some or all of the components of the computing system such as the example computing system illustrated in FIG. 5, using one or more components of the example computing system architecture 500 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 528. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 504 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 514 can be coupled to the processor 504 by, for example, a connector such as connector 506, or a bus. As used herein, a connector or bus such as connector 506 is a communications system that transfers data between components within the computing device 502 and may, in some embodiments, be used to transfer data between computing devices. The connector 506 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 514 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 514 can also include magnetic or optical data storage media including read-only (e.g., CD ROM and DVD ROM) or otherwise (e.g., CD or DVD). The memory can be local, remote, or distributed.

As described above, the connector 506 (or bus) can also couple the processor 504 to the storage device 510, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 510. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 506 can also couple the processor 504 to a network interface device such as the network interface 520. The interface can include one or more of a modem or other such network interfaces including, but not limited to those described herein. It will be appreciated that the network interface 520 may be considered to be part of the computing device 502 or may be separate from the computing device 502. The network interface 520 can include one or more of an analog modem, Integrated Services Digital Network (ISDN) modem, cable modem, token ring interface, satellite transmission interface, or other interfaces for coupling a computer system to other computer systems. In some embodiments, the network interface 520 can include one or more input and/or output (I/O) devices. The I/O devices can include, by way of example but not limitation, input devices such as input device 516 and/or output devices such as output device 518. For example, the network interface 520 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, IP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 502 can be connected to one or more additional computing devices such as computing device 524 via a network 522 using a connection such as the network interface 520. In such embodiments, the computing device 524 may execute one or more services 526 to perform one or more functions under the control of, or on behalf of, programs and/or services operating on computing device 502. In some embodiments, a computing device such as computing device 524 may include one or more of the types of components as described in connection with computing device 502 including, but not limited to, a processor such as processor 504, a connection such as connection 506, a cache such as cache 508, a storage device such as storage device 510, memory such as memory 514, an input device such as input device 516, and an output device such as output device 518. In such embodiments, the computing device 524 can carry out the functions such as those described herein in connection with computing device 502. In some embodiments, the computing device 502 can be connected to a plurality of computing devices such as computing device 524, each of which may also be connected to a plurality of computing devices such as computing device 524. Such an embodiment may be referred to herein as a distributed computing environment.

The network 522 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 522 can be wired connections, wireless connections, or combinations thereof. Communications via the network 522 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 522, within the computing device 502, within the computing device 524, or within the computing resources provider 528 can include information, which also may be referred to herein as content. The information may include text, graphics, audio, video, haptics, and/or any other information that can be provided to a user of the computing device such as the computing device 502. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 502 and presented to a user of the computing device 502 using forms that are perceptible via sight, sound, smell, taste, touch, or other such mechanisms. In some embodiments, communications over the network 522 can be received and/or processed by a computing device configured as a server. Such communications can be sent and received using PUP: Hypertext Preprocessor (“PHP”), Python™, Ruby, Perl® and variants, Java®, HTML, XML, or another such server-side processing language.

In some embodiments, the computing device 502 and/or the computing device 524 can be connected to a computing resources provider 528 via the network 522 using a network interface such as those described herein (e.g. network interface 520). In such embodiments, one or more systems (e.g., service 530 and service 532) hosted within the computing resources provider 528 (also referred to herein as within “a computing resources provider environment”) may execute one or more services to perform one or more functions under the control of, or on behalf of, programs and/or services operating on computing device 502 and/or computing device 524. Systems such as service 530 and service 532 may include one or more computing devices such as those described herein to execute computer code to perform the one or more functions under the control of, or on behalf of, programs and/or services operating on computing device 502 and/or computing device 524.

For example, the computing resources provider 528 may provide a service, operating on service 530 to store data for the computing device 502 when, for example, the amount of data that the computing device 502 exceeds the capacity of storage device 510. In another example, the computing resources provider 528 may provide a service to first instantiate a virtual machine (VM) on service 532, use that VM to access the data stored on service 532, perform one or more operations on that data, and provide a result of those one or more operations to the computing device 502. Such operations (e.g., data storage and VM instantiation) may be referred to herein as operating “in the cloud,” “within a cloud computing environment,” or “within a hosted virtual machine environment,” and the computing resources provider 528 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 528 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 530 and service 532 may implement versions of various services (e.g., the service 512 or the service 526) on behalf of, or under the control of, computing device 502 and/or computing device 524. Such implemented versions of various services may involve one or more virtualization techniques so that, for example, it may appear to a user of computing device 502 that the service 512 is executing on the computing device 502 when the service is executing on, for example, service 530. As may also be contemplated, the various services operating within the computing resources provider 528 environment may be distributed among various systems within the environment as well as partially distributed onto computing device 524 and/or computing device 502.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 502) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 200 of FIG. 2). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistants (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 502.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
accessing text data, wherein the text data includes one or more machine-generated responses that are supplemented by outputs generated by a retrieval-augmentation generation (RAG) system, and wherein the one or more machine-generated responses are associated with a prompt associated with a user;
applying one or more hallucination-detection models to the text data to generate a set of classification labels, wherein a classification label of the set of classification labels indicates whether a corresponding machine-generated response of the one or more machine-generated responses contradicts at least part of a knowledge base accessed by the RAG system, and wherein the one or more hallucination-detection models were trained using a training dataset that includes previous machine-generated responses annotated with the set of classification labels;
generating annotated text data that includes the one or more machine-generated responses annotated with corresponding classification labels of the set of classification labels; and
outputting the annotated text data.

2. The computer-implemented method of claim 1, wherein generating the outputs includes:
encoding the prompt into one or more embeddings, wherein when the one or more embeddings are entered in a database, the RAG system uses prompt results outputted from the database to supplement the one or more machine-generated responses.

3. The computer-implemented method of claim 1, wherein the knowledge base includes domain-specific information, wherein the domain-specific information is associated with a particular domain.

4. The computer-implemented method of claim 1, wherein the set of classification labels includes a no-info classification label indicating that the corresponding machine-generated response includes non-verifiable information, a supported classification label indicating that the corresponding machine-generated response is supported by the knowledge base, and an unsupported classification label indicating that the corresponding machine-generated response contradicts the at least part of the knowledge base.

5. The computer-implemented method of claim 1, wherein the one or more hallucination-detection models include a pretrained Decoding-enhanced Bidirectional Encoder Representations from Transformers with Disentangled attention (DeBERTa) model.

6. The computer-implemented method of claim 1, wherein the one or more hallucination-detection models include a pretrained large-language model (LLM).

7. The computer-implemented method of claim 1, wherein applying the one or more hallucination-detection models to the text data includes:
applying a first hallucination-detection model of the one or more hallucination-detection models to the text data to generate a verifiable classification label indicating that the corresponding machine-generated response includes information verifiable from the knowledge base; and
applying a second hallucination-detection model of the one or more hallucination-detection models to the corresponding machine-generated response to generate the classification label indicating whether the corresponding machine-generated response contradicts at least part of the knowledge base.

8. The computer-implemented method of claim 1, wherein applying the one or more hallucination-detection models to the text data includes:
applying a first hallucination-detection model of the one or more hallucination-detection models to the text data to generate a no-info classification label indicating that the corresponding machine-generated response includes non-verifiable information.

9. The computer-implemented method of claim 1, wherein outputting the annotated text data includes displaying in real-time the annotated text data on a graphical user interface, as messages are exchanged between the user and an agent during an instant-chat session.

10. A system comprising:
one or more processors; and
memory storing thereon instructions that, as a result of being executed by the one or more processors, cause the system to perform operations comprising:
accessing text data, wherein the text data includes one or more machine-generated responses that are supplemented by outputs generated by a retrieval-augmentation generation (RAG) system, and wherein the one or more machine-generated responses are associated with a prompt associated with a user;
applying one or more hallucination-detection models to the text data to generate a set of classification labels, wherein a classification label of the set of classification labels indicates whether a corresponding machine-generated response of the one or more machine-generated responses contradicts at least part of a knowledge base accessed by the RAG system, and wherein the one or more hallucination-detection models were trained using a training dataset that includes previous machine-generated responses annotated with the set of classification labels;
generating annotated text data that includes the one or more machine-generated responses annotated with corresponding classification labels of the set of classification labels; and
outputting the annotated text data.

11. The system of claim 10, wherein generating the outputs includes:
encoding the prompt into one or more embeddings, wherein when the one or more embeddings are entered in a database, the RAG system uses prompt results outputted from the database to supplement the one or more machine-generated responses.

12. The system of claim 10, wherein the knowledge base includes domain-specific information, wherein the domain-specific information is associated with a particular domain.

13. The system of claim 10, wherein the set of classification labels includes a no-info classification label indicating that the corresponding machine-generated response includes non-verifiable information, a supported classification label indicating that the corresponding machine-generated response is supported by the knowledge base, and an unsupported classification label indicating that the corresponding machine-generated response contradicts the at least part of the knowledge base.

14. The system of claim 10, wherein the one or more hallucination-detection models include a pretrained Decoding-enhanced Bidirectional Encoder Representations from Transformers with Disentangled attention (DeBERTa) model.

15. The system of claim 10, wherein the one or more hallucination-detection models include a pretrained large-language model (LLM).

16. The system of claim 10, wherein applying the one or more hallucination-detection models to the text data includes:
applying a first hallucination-detection model of the one or more hallucination-detection models to the text data to generate a verifiable classification label indicating that the corresponding machine-generated response includes information verifiable from the knowledge base; and
applying a second hallucination-detection model of the one or more hallucination-detection models to the corresponding machine-generated response to generate the classification label indicating whether the corresponding machine-generated response contradicts at least part of the knowledge base.

17. The system of claim 10, wherein applying the one or more hallucination-detection models to the text data includes:
applying a first hallucination-detection model of the one or more hallucination-detection models to the text data to generate a no-info classification label indicating that the corresponding machine-generated response includes non-verifiable information.

18. The system of claim 10, wherein outputting the annotated text data includes displaying in real-time the annotated text data on a graphical user interface, as messages are exchanged between the user and an agent during an instant-chat session.

19. A non-transitory, computer-readable storage medium storing thereon executable instructions that, as a result of being executed by one or more processors of a computer system, cause the computer system to perform operations comprising:
accessing text data, wherein the text data includes one or more machine-generated responses that are supplemented by outputs generated by a retrieval-augmentation generation (RAG) system, and wherein the one or more machine-generated responses are associated with a prompt associated with a user;
applying one or more hallucination-detection models to the text data to generate a set of classification labels, wherein a classification label of the set of classification labels indicates whether a corresponding machine-generated response of the one or more machine-generated responses contradicts at least part of a knowledge base accessed by the RAG system, and wherein the one or more hallucination-detection models were trained using a training dataset that includes previous machine-generated responses annotated with the set of classification labels;
generating annotated text data that includes the one or more machine-generated responses annotated with corresponding classification labels of the set of classification labels; and
outputting the annotated text data.

20. The non-transitory, computer-readable storage medium of claim 19, wherein generating the outputs includes:
encoding the prompt into one or more embeddings, wherein when the one or more embeddings are entered in a database, the RAG system uses prompt results outputted from the database to supplement the one or more machine-generated responses.

21. The non-transitory, computer-readable storage medium of claim 19, wherein the knowledge base includes domain-specific information, wherein the domain-specific information is associated with a particular domain.

22. The non-transitory, computer-readable storage medium of claim 19, wherein the set of classification labels includes a no-info classification label indicating that the corresponding machine-generated response includes non-verifiable information, a supported classification label indicating that the corresponding machine-generated response is supported by the knowledge base, and an unsupported classification label indicating that the corresponding machine-generated response contradicts the at least part of the knowledge base.

23. The non-transitory, computer-readable storage medium of claim 19, wherein the one or more hallucination-detection models include a pretrained Decoding-enhanced Bidirectional Encoder Representations from Transformers with Disentangled attention (DeBERTa) model.

24. The non-transitory, computer-readable storage medium of claim 19, wherein the one or more hallucination-detection models include a pretrained large-language model (LLM).

25. The non-transitory, computer-readable storage medium of claim 19, wherein applying the one or more hallucination-detection models to the text data includes:
applying a first hallucination-detection model of the one or more hallucination-detection models to the text data to generate a verifiable classification label indicating that the corresponding machine-generated response includes information verifiable from the knowledge base; and
applying a second hallucination-detection model of the one or more hallucination-detection models to the corresponding machine-generated response to generate the classification label indicating whether the corresponding machine-generated response contradicts at least part of the knowledge base.

26. The non-transitory, computer-readable storage medium of claim 19, wherein applying the one or more hallucination-detection models to the text data includes:
applying a first hallucination-detection model of the one or more hallucination-detection models to the text data to generate a no-info classification label indicating that the corresponding machine-generated response includes non-verifiable information.

27. The non-transitory, computer-readable storage medium of claim 19, wherein outputting the annotated text data includes displaying in real-time the annotated text data on a graphical user interface, as messages are exchanged between the user and an agent during an instant-chat session.
